(19) United States
(12) Patent Application Publication
(10) Pub. No.: US 2026/0073787 A1
(43) Pub. Date: Mar. 12, 2026

(54) SKIMMING DEVICE AS COMMUNICATION UNIT FOR SWIMMING POOL OR SPA

(71) Applicant: ZODIAC POOL SYSTEMS LLC, Carlsbad, CA (US)

(72) Inventor: Mark J. Bauckman, San Marcos, CA (US)

(73) Assignee: ZODIAC POOL SYSTEMS LLC, Carlsbad, CA (US)

(21) Appl. No.: 19/308,616

(22) Filed: Aug. 25, 2025

Related U.S. Application Data
(60) Provisional application No. 63/693,168, filed on Sep. 10, 2024.

(51) Int. Cl. G08C 19/00; E04H 4/12; E04H 4/16

(52) U.S. Cl. CPC G08C 19/00; E04H 4/1263; E04H 4/1654

(57) ABSTRACT

Pool systems for swimming pools or spas may include one or more automatic skimming devices which function as a communication unit for one or more submerged devices. The one or more skimming devices may function as a communication unit by communicating with another device, which may be submerged or external to the pool. Additionally, or alternatively, the skimming device may function as a communication unit by providing a user interface remote from the submerged device and which may be utilized to interact with the submerged device.

### REFERENCE TO RELATED APPLICATION

This application claims the benefit of and priority to U.S. Provisional Ser. No. 63/693,168, filed on Sep. 10, 2024, and entitled SKIMMING DEVICE AS COMMUNICATION UNIT FOR SWIMMING POOL OR SPA, the content of which is hereby incorporated by reference in its entirety.

### FIELD OF THE INVENTION

The invention relates to cleaning devices for swimming pools and spas, and more particularly, although not necessarily exclusively, to devices for skimming debris from upper water surfaces or waterline surfaces.

### BACKGROUND OF THE INVENTION

Debris entering a swimming pool or spa may first float at or near an upper surface of the water before sinking to the bottom of the swimming pool or spa. Many pool owners and pool systems utilize skimmers to attempt to remove surface debris before it sinks to keep the pool water clean and disinfected and to prevent bulky debris from potentially damaging equipment of the pool. Various types of skimmers exist, including hand-held skimmer nets, skimmers associated with a main pool filtration system, and self-propelled or automatic floating skimmers.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a pool system includes an automatic water skimming device configured to move along a surface of the pool and a device submerged within the pool. The automatic water skimming device may be configured to send and/or receive information from the device submerged within the pool.

According to some embodiments, a pool system includes an automatic water skimming device configured to move along a surface of the pool, and the automatic water skimming device includes an onboard user interface for communicating with a submerged device.

According to various embodiments, a pool system includes a device submerged within a pool and an automatic water skimming device configured to move along a surface of the pool. In certain embodiments, the automatic water skimming device is configured as a communication unit for the device submerged within the pool.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system with a skimming device and a submerged device according to embodiments.

FIG. 2 is another view of the pool system of FIG. 1 with the skimming device and the submerged device according to embodiments.

FIG. 3 is another view of the pool system of FIG. 1 with the skimming device and the submerged device according to embodiments.

### DETAILED DESCRIPTION

Described herein are pool systems for swimming pools or spas with one or more automatic skimming devices functioning as a communication unit for one or more submerged devices. In some embodiments, the skimming device may function as a communication unit by communicating with another device, which may be submerged or external to the pool. Additionally, or alternatively, the skimming device may function as a communication unit by providing a user interface remote from the submerged device (i.e., onboard the skimming device) which may be utilized to send information, receive information, and/or otherwise interact with the submerged device. In certain embodiments, the pool systems described herein may utilize the automatic skimming device, which navigates and cleans along the surface of the pool, to provide improved communication with submerged devices.

The submerged devices may be various devices or equipment as desired, such as but not limited to automatic pool cleaners, docking stations, sensors, lights, other pool equipment, combinations thereof, and/or as otherwise desired. In certain embodiments, the automatic skimming device may function as the communication unit such that the one or more submerged devices may communicate with various external devices. Such external devices may be within the pool or remote from the pool as desired and may be various types of devices such as but not limited to other pool equipment, a user device, a remote device, etc.

In various embodiments, by utilizing the automatic skimming device as a communication unit for the submerged device, the submerged device may be simplified and/or need not include complex communication modules and/or may have improved communication capability. Various other benefits and advantages may be realized with the systems, devices, and methods provided herein, and the aforementioned advantages should not be considered limiting.

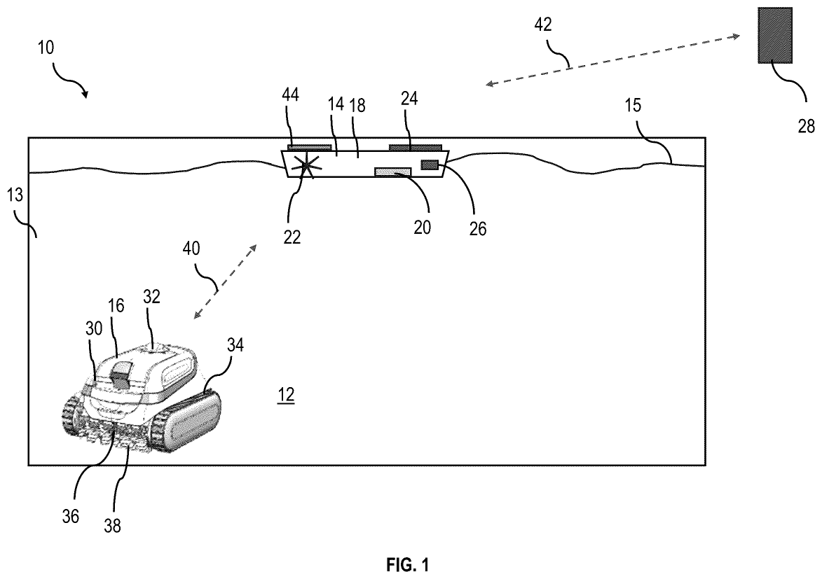

FIGS. 1-3 illustrate an example of a pool system 10 with a swimming pool or spa 12 (hereinafter “pool 12”), one or more skimming devices 14, and one or more submerged devices 16 according to embodiments.

The pool 12 may have various shapes, sizes, and dimensions, as desired, and those illustrated in FIGS. 1-3 should not be considered limiting. In various embodiments, water 13 of the pool 12 includes a waterline 15.

The skimming device 14 may be various types of devices that stay at, on, and/or at least partially above the waterline 15 and are generally configured to clean debris at or on the waterline 15 (referred to as a “skimming operation” or “waterline cleaning operation”). In certain embodiments, the skimming device 14 is a floating device configured for navigating and cleaning along the surface of the water 13.

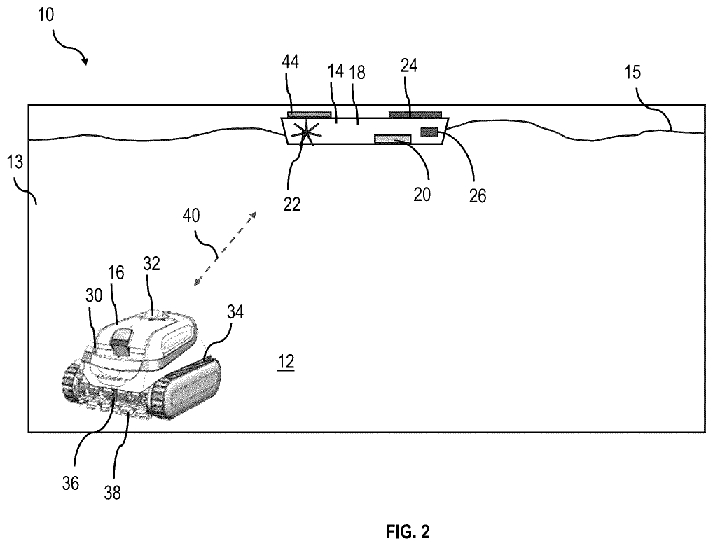

The skimming device 14 generally includes a body 18 which may be buoyant and may have various shapes, sizes, or configurations as desired. The body 18 may house and/or be attached to a filter assembly 20, which may be various devices or mechanisms suitable for filtering debris from water. As non-limiting examples, the filter assembly 20 may include a mesh screen and/or a frame with a filtering material attached thereto with various porosity levels as desired. While the filter assembly 20 is illustrated within the body 18 in FIGS. 1 and 2, it need not be in other embodiments and instead may be at various other locations on or relative to the body 18 as desired. In operation, water may be directed by the skimming device 14 through the filter assembly 20 to remove debris at the waterline 15.

Optionally, one or more propulsion devices 22 may be provided to direct the skimming device 14 through the water and/or to facilitate collection of debris. The number, shape, type, and location of the propulsion devices 22 should not be considered limiting. In this regard, the skimming device 14 may be an “automatic” skimming device 22 capable of self-propelled motion or movement in the pool 12. In other embodiments, the skimming device 14 need not be self-propelled.

In certain embodiments, and as illustrated in FIGS. 1 and 2, the skimming device 14 includes one or more onboard power-generating devices, such as but not limited to one or more onboard solar cells 24, for supplying energy to various electrical components of the skimming device 14. The solar cells 24 may be provided at various locations on the skimming device 14 as desired, such as but not limited to various locations on the body 18. In certain embodiments, the solar cells 24 may be fixed relative to the body 18, although in other embodiments, the solar cells 24 may be detachable from the body 18 such that the solar cells 24 are adjustable or movable as desired. Optionally, the skimming device 14 may include one or more batteries for storing energy generated by the one or more solar cells 24 and/or as otherwise desired. In some embodiments, the skimming device 14 is not solar powered and instead is powered by one or more batteries and/or by receiving power through a cable from an external power source.

Optionally, the skimming device 14 includes one or more communication modules allowing for wired or wireless communication (e.g., Bluetooth, Li-Fi, LoRa, radio frequency, cellular, NFC, Wi-Fi, etc.) with external or remote devices, such as but not limited to external control devices, the internet, cloud services, smartphones, other user devices, other pool equipment, etc. In certain embodiments, and as discussed in detail below, the skimming device 14 is configured to function as a communication unit for the submerged device 16, and the skimming device 14 is in communication with both the submerged device 16 and an external device 28.

Optionally, and as illustrated in FIGS. 1 and 2, the skimming device 14 includes a user interface 42 onboard the skimming device 14. The user interface 42 may be various suitable interfaces as desired, including but not limited to a graphical user interface or a human machine interface, such that the skimming device 14 may obtain information from a user and/or provide information to the user. The user interface 42 may include various features such as but not limited to a screen, display, speaker, keypad, light source, combinations thereof, etc. Optionally, and as discussed in detail below, the user interface 42 onboard the skimming device 14 may function as a user interface for both the skimming device 14 and the submerged device 16.

In certain embodiments, the skimming device 14 optionally may include a controller 26 with one or more processing units and/or one or more memory devices on and/or associated with the skimming device 14. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

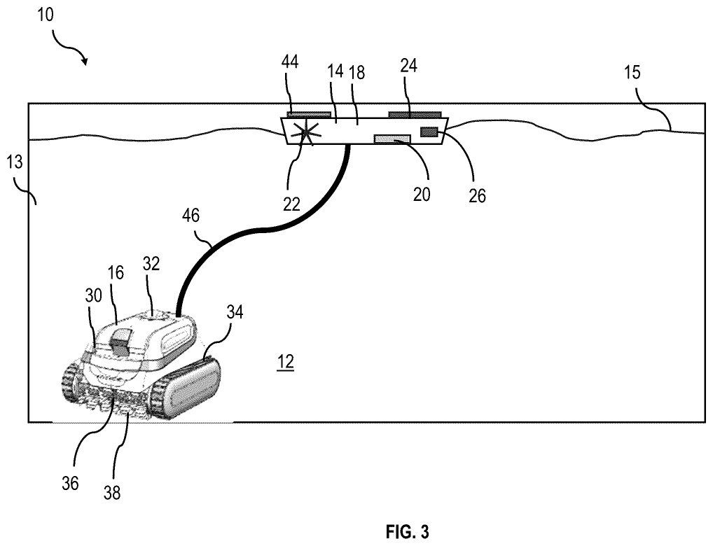

The one or more submerged devices 16 may be various devices submerged within the pool 12. Non-limiting examples of submerged devices 16 include but are not limited to automatic swimming pool cleaners configured to clean a submerged surface of the pool 12, docking stations, lights, sensors, combinations thereof, and/or as otherwise desired. In various embodiments, the submerged device 16 may be configured for wired or wireless communication with the automatic skimming device 14 as discussed in detail below. In some embodiments, the submerged device 16 may be tethered to the skimming device 14 using a tether or cabling 46 (see FIG. 3). In such embodiments, the tether 46 optionally includes cabling or wiring enabling wired communication between the submerged device 16 and the skimming device 14. In other embodiments where the skimming device 14 is tethered to the submerged device 16, the communication may be wired or wireless communication as desired. In other embodiments, and as illustrated in FIGS. 1 and 2, the skimming device 14 need not be tethered to the submerged device 15.

In the embodiment illustrated in FIGS. 1-3, the submerged device 16 is an automatic swimming pool cleaner 30. The automatic swimming pool cleaner 30 generally includes a body 32 which is movable relative to (e.g., along) one or more submerged surfaces of the pool 12. The automatic pool cleaner 30 may include motive elements 34, which may be various suitable devices or structures suitable for propelling and/or otherwise causing movement of the pool cleaner 30 along a surface, such as but not limited to a floor of the pool 12, a wall of the pool 12, a step of the pool 12, a beach of the pool 12, a bench of the pool 12, a shelf of the pool 12, a ledge of the pool 12, combinations thereof, and/or other surfaces as desired. In this regard, the pool cleaner 30 may be a self-propelled pool cleaner capable of autonomous or semi-autonomous movement within the pool 12. Non-limiting examples of motive elements 34 include, but are not limited to, wheels, rollers, feet, tracks, propellers, combinations thereof, and/or other suitable motive elements 34 as desired.

The automatic swimming pool cleaner 30 may include various components on and/or within the body 32 such as a motor block, a filter, a pump, a controller, etc. The automatic swimming pool cleaner 30 optionally may include one or more cleaning elements 36 (e.g., a brush assembly 38 with one or more brushes) suitable for cleaning a surface and/or directing debris into the automatic swimming pool cleaner 30 and/or towards a filter of the automatic swimming pool cleaner 30.

In various embodiments, the submerged nature of the automatic swimming pool cleaner 30 (or other submerged device 16) within the pool 12 may limit communication capabilities of the submerged device 16 to communicate with the external device 28 and/or other devices which may or may not be within the pool 12. To address such limitations, and to provide improved communication capabilities to the submerged device 16, in various embodiments the automatic skimming device 14 may function as a communication unit for the submerged device 16.

In some embodiments, and as illustrated in FIG. 1, the skimming device 14 may function as a communication device for the submerged device 16 such that the submerged device 16 may communicate with the external device 28 through and/or using the automatic skimming device 14. Additionally, or alternatively, the skimming device 14 may function as a communication unit by providing the onboard user interface 44. In such embodiments, while the onboard user interface 44 is remote from the submerged device 16, the onboard user interface 44 may be utilized to send information, receive information, and/or otherwise interact with the submerged device 16.

As a non-limiting example, and as illustrated in FIG. 1, a first communication 40 sending and/or receiving information may be established between the submerged device 16 and the automatic skimming device 14. Optionally, a second communication 42 sending and/or receiving information may be established between the automatic skimming device 14 and the external device 28. The information in the communications 40, 42 may be informational (e.g., status information, sensor information, etc.), control signals (e.g., controlling operation of the submerged device 16, changing operation of the submerged device 16, halting operation of the submerged device 16, interrupting operation of the submerged device 16, etc.), and/or other types of information or combinations thereof as desired. In various embodiments, the first communication 40 may be wired or wireless communication. In some embodiments, the second communication 42 may be wireless communication. Various information may be conveyed from or to the submerged device 16 using the automatic skimming device 14 as desired such as but not limited to various control information, operational information, combinations thereof, and/or as otherwise desired.

As a non-limiting example, the communication 42 from the external device 28 to the skimming device 14 may be an instruction for causing the submerged device 16 to halt a cleaning cycle, and the skimming device 14 may provide the instruction to the submerged device 16 via communication 40. As another non-limiting example, the submerged device 16 may send communication 40 to the skimming device 14 indicating that onboard battery of the submerged device 16 has a low charge level, and the skimming device 14 may indicate the low charge level on the user interface 44 and/or provide the indication to the external device 28 via communication 42. The aforementioned examples are for illustrative purposes only, and other communication may be provided and/or utilized as desired.

By using the automatic skimming device 14 as a communication unit, the submerged device 16 may effectively communicate with external devices 28 (which otherwise may not be able to communicate with the submerged device 16) and allow for simplified communication by the submerged device 16. While communication 42 in FIG. 1 is illustrated with the external device 28, in other embodiments, another device receiving and/or sending the communication 42 need not be external to the pool 12. As a non-limiting example, the communication 40 may be between a first submerged device 16 and the skimming device 14, and the communication 42 may be between a second submerged device 16 and/or another device within the pool 12. Other combinations of communication with devices submerged and/or outside of the pool 12 may be utilized as desired.

As another non-limiting example, and as illustrated in FIG. 2, the communication 40 between the submerged device 16 and the skimming device 14 may be established. Optionally, the user interface 44 onboard the skimming device 14 may be used to convey information received by the submerged device 16 to a user and/or may be used to provide information to the submerged device 16 even though the user interface 44 is remote from the submerged device 16. In this regard, the user interface 44 may function as the user interface for both the skimming device 14 and the submerged device 16, thereby allowing a user to obtain and/or provide information to the submerged device 16 without requiring the submerged device 16 to surface. As non-limiting examples, the submerged device 16 may provide information in the communication 40 such as but not limited to operational status, filter status, battery status, cleaning cycle information, water quality information, water temperature information, debris information, navigation information, combinations thereof, and/or as otherwise desired, to the skimming device 14, which in turn may provide such information (or associated information) to a user via the user interface 44 (e.g., by displaying on a screen, providing an auditory alert, providing a light source, providing other visual alerts or indications, combinations thereof, etc.). Additionally, or alternatively, a user at the waterline and/or on the pool deck near a location of the skimming device 14 in the pool 12 may provide information (e.g., an operational schedule, navigation control, cleaning cycle information, operational control, etc.) to the user interface 44, which in turn is communicated to the submerged device 44 via the communication 40. In certain embodiments, and as illustrated in FIG. 1, the skimming device 14 may be configured for communication both with another device and via the user interface 44 as desired.

Various other combinations of features may be utilized as desired, and the aforementioned examples should not be considered limiting.

Exemplary concepts or combinations of features of the invention may include:

A. A pool system comprising:
i. an automatic water skimming device configured to move along a surface of the pool; and
ii. a device submerged within the pool,
iii. wherein the automatic water skimming device is configured to send and/or receive information from the device submerged within the pool.

B. A pool system comprising an automatic water skimming device configured to move along a surface of the pool, the automatic water skimming device comprising an onboard user interface for communicating with a submerged device.

C. A pool system comprising:
i. a device submerged within a pool; and
ii. an automatic water skimming device configured to move along a surface of the pool, wherein the automatic water skimming device is configured as a communication unit for the device submerged within the pool.

D. The pool system of any preceding or subsequent statement or combination of statements, wherein the automatic water skimming device is configured as a communication unit for the device submerged within the pool by providing an onboard user interface and/or communicating with another device.

E. The pool system of any preceding or subsequent statement or combination of statements, wherein the automatic water skimming device comprises an onboard user interface configured to receive information from user for the submerged device and/or to provide information to the user from the submerged device.

F. The pool system of any preceding or subsequent statement or combination of statements, wherein the device submerged within the pool is an automatic swimming pool cleaner.

G. The pool system of any preceding or subsequent statement or combination of statements, wherein the automatic skimmer device is configured to perform a skimmer operation.

H. The pool system of any preceding or subsequent statement or combination of statements, wherein the automatic water skimming device is further configured to send and/or receive information from an external device and communicate the sent and/or received information to the device submerged within the pool.

I. The pool system of any preceding or subsequent statement or combination of statements, wherein the external device is a piece of pool equipment.

J. The pool system of any preceding or subsequent statement or combination of statements, wherein the external device is a user device or a remote device remote from the pool.

K. The pool system of any preceding or subsequent statement or combination of statements, wherein the automatic water skimming device is tethered to the device submerged within the pool.

L. The pool system of any preceding or subsequent statement or combination of statements, wherein communication between the device submerged within the pool and the automatic water skimming device is wired or wireless communication.

M. The pool system of any preceding or subsequent statement or combination of statements, wherein communication between the automatic water skimming device and the external device is wireless communication.

N. The pool system of any preceding or subsequent statement or combination of statements, wherein the automatic water skimming device comprises one or more solar cells.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with skimming devices, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A pool system comprising:
an automatic water skimming device configured to move along a surface of the pool; and
a device submerged within the pool,
wherein the automatic water skimming device is configured to send and/or receive information from the device submerged within the pool.

2. The pool system of claim 1, wherein the automatic water skimming device is configured as a communication unit for the device submerged within the pool and comprises an onboard user interface.

3. The pool system of claim 1, wherein the automatic water skimming device is configured as a communication unit for the device submerged within the pool and is configured to communicate with another device.

4. The pool system of claim 1, wherein the automatic water skimming device comprises an onboard user interface configured to receive information from user for the submerged device and/or to provide information to the user from the submerged device.

5. The pool system of claim 1, wherein the device submerged within the pool is an automatic swimming pool cleaner.

6. The pool system of claim 1, wherein the automatic water skimming device is further configured to send and/or receive information from an external device and communicate the sent and/or received information to the device submerged within the pool.

7. The pool system of claim 1, wherein the external device is a piece of pool equipment.

8. The pool system of claim 1, wherein the automatic water skimming device is configured to perform a skimming operation.

9. The pool system of claim 1, wherein the automatic water skimming device is tethered to the device submerged within the pool.

10. The pool system of claim 1, wherein communication between the device submerged within the pool and the automatic water skimming device is wired or wireless communication.

11. The pool system of claim 10, wherein communication between the automatic water skimming device and an external device is wireless communication.

12. The pool system of claim 10, wherein the automatic water skimming device comprises one or more solar cells.

13. A pool system comprising an automatic water skimming device configured to move along a surface of the pool, wherein the automatic water skimming device comprises an onboard user interface for communicating with a submerged device.

14. The pool system of claim 13, wherein the automatic water skimming device is configured to communicate with the submerged device using wireless communication.

15. The pool system of claim 13, wherein the automatic water skimming device is tethered to the submerged device and is configured to communicate with the submerged device using wired communication.

16. A pool system comprising:
a device submerged within a pool; and
an automatic water skimming device configured to move along a surface of the pool, wherein the automatic water skimming device is configured as a communication unit for the device submerged within the pool.

17. The pool system of claim 16, wherein the automatic water skimming device comprises an onboard user interface configured to receive information from user for the submerged device and/or to provide information to the user from the submerged device.

18. The pool system of claim 16, wherein the automatic water skimming device is further configured to send and/or receive information from an external device and communicate the sent and/or received information to the device submerged within the pool.

19. The pool system of claim 16, wherein the automatic water skimming device is tethered to the device submerged within the pool.

20. The pool system of claim 16, wherein communication between the device submerged within the pool and the automatic water skimming device is wired or wireless communication.
